(19) United States
(12) Patent Application Publication
(10) Pub. No.: US 2026/0065076 A1
(43) Pub. Date: Mar. 5, 2026

(54) HYBRID META LEARNING FOR AGNOSTIC RECOMMENDER PLATFORMS

(71) Applicant: Microsoft Technology Licensing, LLC, Redmond, WA (US)

(72) Inventors: Prakruthi PRABHAKAR, Santa Clara, CA (US); Ruofan WANG, Sunnyvale, CA (US); Gaurav SRIVASTAVA, San Francisco, CA (US); Yunbo OUYANG, San Jose, CA (US)

(21) Appl. No.: 18/818,747

(22) Filed: Aug. 29, 2024

(51) Int. Cl. G06N 3/0985

(52) U.S. Cl. CPC G06N 3/0985

(57) ABSTRACT

Aspects of the disclosure include methods and systems for meta learning, and specifically to hybrid meta learning for agnostic recommender platforms. A method includes receiving, by a global block ranker of a hybrid meta learning recommendation service, a request corresponding to an entity in a network. A meta block encoder generates, at a first cadence decoupled from the request, a meta embedding of an entity-specific meta feature of the entity. The meta embedding is aggregated with one or more non-meta features at a second cadence responsive to the request and the aggregated data is input to the global block ranker. A prediction score is generated for each candidate of one or more candidates corresponding to the request and a response including a candidate is returned using the prediction score.

### INTRODUCTION

The subject disclosure relates to machine learning, online platforms, and content recommendation, and specifically to hybrid meta learning for agnostic recommender platforms.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a hybrid meta learning recommendation service in accordance with one or more embodiments;

FIGS. 2A and 2B depict block diagrams for training the meta blocks and global block of FIG. 1, respectively, in accordance with one or more embodiments;

FIG. 3A depicts an example MLP-type implementation for a meta block in accordance with one or more embodiments;

FIG. 3B depicts an example ID embedding layer-type implementation for a meta block in accordance with one or more embodiments;

FIG. 4 depicts an example transformer-type implementation for a meta block in accordance with one or more embodiments;

FIG. 5 depicts a block diagram of a computer system according to one or more embodiments; and

FIG. 6 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

In the realm of connections networks and recommender platforms, the universal adoption of deep neural networks has emerged as a dominant paradigm for modeling diverse business objectives. Specifically, recommender platforms increasingly rely upon neural-network based recommendation models for modeling objectives such as click-through rate (CTR) prediction, invite prediction, and visit prediction, among others. As user bases continue to expand, model personalization and model update frequency have become ever more critical features to ensure the delivery of relevant and refreshed experiences to a diverse array of members. In general, the definition of “model personalization” varies across different objectives and applications. As an example, for an advert-CTR prediction task, an objective might be to build personalized models for each advertiser ID. For a general user-item CTR prediction task, an objective might be to build personalized models for each user. For a model that predicts whether or not a user would apply for a job, a per-user and job-to-industry segment level personalization might make more sense.

In a meta learning framework, model personalization entails designing different task definitions for different use cases. With meta learning, the goal is to quickly and effectively learn a new task from a small number of data samples using a model that is learnt on a large number of different tasks.

Unlike Model-Agnostic Meta-Learning (MAML)-based approaches, such as the Meta-Learned User Preference Estimator (MeLU), MAML-based approaches are natively limited in scale. In short, it is nearly infeasible to productionize MAML-based approaches like MeLU because, in those architectures, the entire network is meta learned. More specifically, task adaptation layers are the last layer(s) in the model, which necessitates the storing of the personalization weights of all the N entities/tasks (e.g., members, advertisers, users, etc.) for which task personalization is desired. This constraint may be acceptable in a research setting, but quickly becomes untenable as the number of entities (or tasks) N increases to production scale. Observe, for example, that the number of entities N can exceed 10s of millions, 100s of millions, or even billions of entities in large scale online platforms such as connections networks. As a result, as N increases to production scale, the storage required to store all model parameters for all tasks and the latency experienced when fine-tuning those tasks online increase rapidly.

This disclosure introduces a hybrid meta learning system and framework for agnostic recommender platforms. Rather than meta learning the entire network, the hybrid meta learning system described herein divides the network into two block types-meta blocks and the global block. In this hybrid paradigm entity-specific meta blocks are leveraged continuously and/or periodically in an offline pipeline to generate meta embeddings from entity-specific meta features. Notably, the number of meta blocks can be arbitrarily large without impacting online latency due to this construction. In contrast, the global block is leveraged in an online pipeline. Advantageously, the global block receives a hybrid input that includes both the meta embeddings generated offline by the meta blocks and a plurality of non-meta features (also referred to as global features, shared features, or other features) which are sourced in the online pipeline.

The hybrid meta learning system described herein offers a number of architectural advantages over traditional MAML-based approaches. For example, decoupling the network into meta blocks and the global block enables a new training regime in which only the meta blocks are meta learned. Model serving is significantly streamlined, as a hybrid serving solution is provided in which the arbitrarily large number of meta blocks are served offline, while only the global block is served online. Storage requirements are substantially reduced as well. MAML-based approaches store all model parameters for all tasks, while, in contrast, the present architecture only stores an embedding vector per task (the meta embeddings). Latency is also improved relative to MAML-based approaches, as there is no inference latency overhead due to repositioning fine-tuning offline. Finally, the predictions made by the hybrid meta learning system described herein can be incorporated within or coupled to existing recommender systems without requiring complex modifications to those systems (e.g., the predictions can be fed directly to recommender systems as input), allowing the deeply personalized meta learned models to be leveraged with existing recommenders.

### DETAILED EMBODIMENT

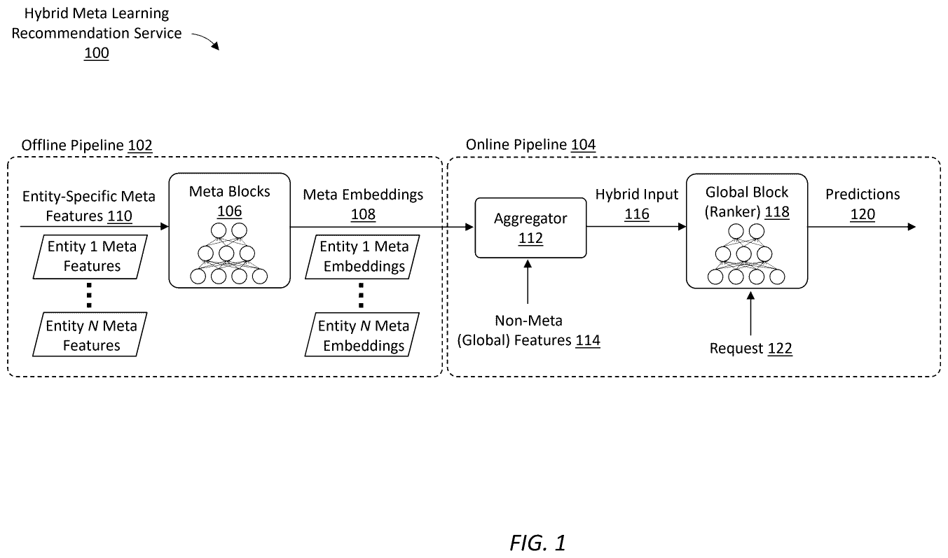

FIG. 1 depicts a block diagram for a hybrid meta learning recommendation service 100 in accordance with one or more embodiments. As will be described in further detail herein, the hybrid meta learning recommendation service 100 splits features into meta learning features and non-meta learning features. As used herein, “meta learning features” or simply meta features are defined as the set of task-specific (or entity-specific) features for which a personalized representation is required. Conversely, as used herein, “non-meta learning features” are defined as the set of features which are not in the set of task-specific features or entity-specific features (that is, the remaining features), also referred to as global and/or shared features, for which a personalized representation is not required. For example, consider a scenario in which a recommender platform is selecting a feed post for serving to a user of a connections network. In that scenario, the user (or member, or viewer, etc.) is defined as the entity of interest (or, generally, as the “task”), the meta features include entity-specific features such as the user's activity level, the user's last N viewed posts, etc., and non-meta features would include the actual candidate feed post features (e.g., how long is the post, which hashtags are present in the post, etc.). Observe that the meta features (here, a given user's various features) are specific to each respective entity/task, while the other features (e.g., candidate post features) are common to all entities/tasks.

It should be readily appreciated that meta features and non-meta features will depend upon the task definition. Thus, defining the task is one of the critical first steps in initializing the hybrid meta learning recommendation service 100. The goal of personalizing the hybrid meta learning recommendation service 100 via hybrid meta learning is to effectively and quickly learn to produce fine-tuned network weights for each new task. If the learning objective is to predict CTR on an item from a user, each user or user segment could be a natural choice of task definition for this problem. In general, the available inputs to a neural network in a recommender system usually consist of a set of one or more entities and their corresponding features. Examples of entities include job ID, advertiser ID, viewer ID, etc. Accordingly, one or more combinations of entities or their segmentation would be a good choice in designating the task for meta learning. For example, consider a scenario in which each viewer ID is treated as a task. In that scenario, a task Tᵢ can be defined as the set of all data points for a particular viewer i and the outcome of meta learning would be to produce per-viewer personalized networks based on most recent viewer interaction data.

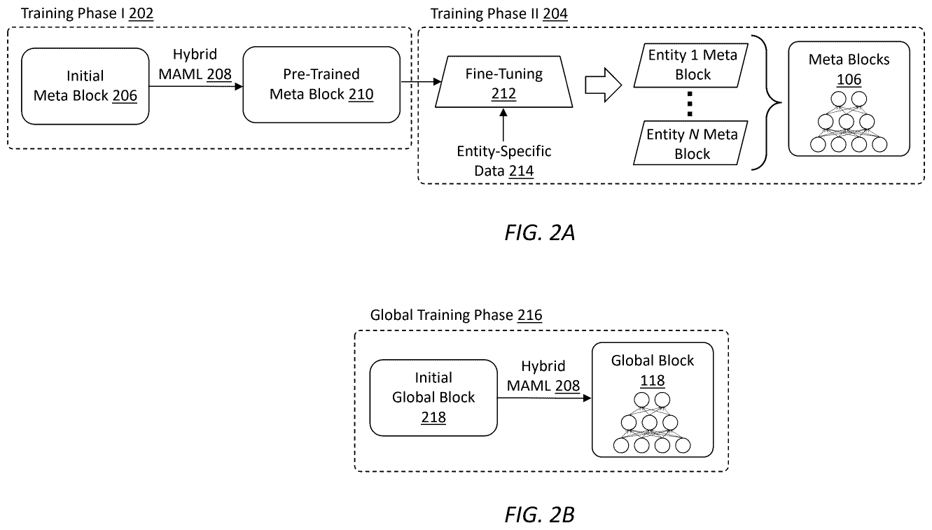

As shown in FIG. 1, the hybrid meta learning recommendation service 100 is split into an offline pipeline 102 and an online pipeline 104. In some embodiments, the offline pipeline 102 involves leveraging entity-specific (or task-specific) meta blocks 106 that are meta trained to generate one or more meta embeddings 108 from one or more corresponding entity-specific meta features 110. An architecture for training the meta blocks 106 is discussed in greater detail below with respect to FIG. 2A. In some embodiments, a personalized (unique) meta block 106 is generated for each of N tasks (that is, for each of N entities when entities are defined as the task as described above). In some embodiments, the entity-specific meta features 110 include entity 1 meta features, entity 2 meta features, . . . , entity N meta features for N entities. In some embodiments, the meta embeddings 108 (as referred to as meta-learnt entity representations) include entity 1 meta embeddings, entity 2 meta embeddings, . . . , entity N meta embeddings. Thus, in some embodiments, a specific entity k's meta block 106 receives, as input, entity k meta features and generates, as output, a respective entity k meta embedding. This procedure is repeated for all N entities. Advantageously, N can be arbitrarily large without impacting the latency of the online pipeline 104. In some embodiments, the size of N is on the order of a few million, tens of millions, hundreds of millions, or even billions.

In some embodiments, the online pipeline 104 receives, as input, the meta embeddings 108 generated during the offline pipeline 102 by the meta blocks 106. In some embodiments, the online pipeline 104 includes an aggregator 112 which receives the meta embeddings 108. In some embodiments, aggregator 112 further receives, in addition to the meta embeddings 108, a set of non-meta features 114 (also referred to as global features, shared features, and/or other features). Observe that the online pipeline 104 receives meta learned meta embeddings 108 as well as non-meta features 114. Thus, the online pipeline 104 (and the hybrid meta learning recommendation service 100) can be considered to be a hybrid meta learning architecture. Notably, this type of hybrid architecture shifts the storage and compute burden associated with the meta blocks 106 to the offline pipeline 102, significantly lowering resource requirements and latency for the online pipeline 104 without sacrificing the model personalization benefits of meta learning.

In some embodiments, aggregator 112 generates a hybrid input 116 from the meta embeddings 108 and the non-meta features 114. In some embodiments, aggregator 112 generates the hybrid input 116 by concatenating the meta embeddings 108 and the non-meta features 114, although other techniques are possible. Alternatively, or in addition, aggregator 112 can generate the hybrid input 116 by combining the meta embeddings 108 with the non-meta features 114 using cosine similarly or any other similarity metric. In any case, the hybrid input 116 is fed to a global block 118 to generate one or more predictions 120.

The global block 118 represents the sub-network that is shared across all tasks and, in some embodiments, can be equivalent in architecture to the underlying network structure currently deployed for a given application. For example, in the context of a recommender platform for a connections network, global block 118 can be implemented as a ranker (e.g., first pass ranker, second pass ranker, etc.). In this type of configuration, global block 118 can be trained to receive a request 122 and, in response, to generate the predictions 120 from the hybrid input 116 and rank (or score) the resulting predictions 120 for serving/service purposes. The request 122 is not meant to be particularly limited and can include any desired task such as, for example, a request for a feed post for a particular user, an advert selection, a connection recommendation for a member, an advert-CTR prediction task, a user-item CTR prediction task, etc. For example, consider a scenario in which a feed post is to be selected from a group of candidate posts as an impression for a user of a connections network. The user is the task, the user's features are the entity-specific meta features 110, and the candidate post features are the non-meta features 114. The resulting meta embedding(s) 108 generated by that user's meta block 106 can be combined as desired with the non-meta features 114 and fed to the global block 118 to generate, and then rank, the predictions 120. One or more feed posts can then be selected from the ranked predictions 120 and served to the user as desired (e.g., the highest scoring feed post, top K feed posts, etc.). An architecture for training the global block 118 is discussed in greater detail with respect to FIG. 2B.

Observe that the hybrid meta learning architecture described with respect to FIG. 1 offers both network decoupling (that is, a network is split into meta blocks and a global block) and hybrid serving (that is, meta learning is served offline while global scoring/ranking is served online). As used herein, offline serving refers to the set of processes which occur prior to receiving request 122. Conversely, as used herein, online serving refers to the set of processes which occur after or responsive to receiving request 122. Online storage is also improved, as meta embeddings 108 are relatively easier to store than the meta blocks 106. In particular, meta embeddings 108 will be on the order of a few digits, a few flows, etc., while the meta blocks 106 are individualized models having arbitrarily large parameter sets (e.g., millions or even billions of parameters as described previously). Moreover, the number N of meta blocks 106 can also be large, as individualized meta blocks 106 can be generated for all tasks (entities) in a network. In short, generating and storing the meta blocks 106 offline while leveraging the resulting representations (the meta embeddings 108) online allows the hybrid meta learning recommendation service 100 to scale meta learning in a manner that is simply not possible using MAML-based approaches such as MeLU.

FIGS. 2A and 2B depict block diagrams for training the meta blocks 106 and global block 118 of FIG. 1, respectively, in accordance with one or more embodiments. As shown in FIG. 2A, meta blocks 106 can be trained using a two-phase training regime that includes a first training phase 202 (as shown, training phase I) and a second training phase 204 (as shown, training phase II). During the first training phase 202, a meta block is initialized randomly or otherwise as desired (resulting, as shown, in initial meta block 206) and meta trained via a hybrid MAML algorithm 208 (or simply hybrid MAML 208) to generate a pre-trained meta block 210. The hybrid MAML algorithm 208 is discussed in greater detail below.

Notably, the pre-trained meta block 210 is a common ancestor to each of the resulting meta blocks 106 (refer to FIG. 1). During the second training phase 204, the pre-trained meta block 210 undergoes, for each task (for each entity), fine-tuning 212 against entity-specific data 214, thereby generating one or more entity-specific meta blocks 106 (as shown, the “Entity 1 Meta Block”, “Entity 2 Meta Block”, . . . , “Entity N Meta Block”). In other words, during the second training phase 204, a meta block 106 can be generated for each entity by fine-tuning over the entity-specific data 214 for that respective entity. This process can be repeated for as many tasks or entities as desired to generate any number of meta blocks 106 from a single pre-trained meta block 210.

The entity-specific data 214 includes the entity-specific meta features 110 (refer to FIG. 1) for that respective entity, non-meta features 114 (refer to FIG. 1), and corresponding training labels. Observe that the training labels used to generate the meta blocks 106 will vary between the various entities, as each given entity will have a different known label or “ground truth” with respect to the entity-specific meta features 110 and/or non-meta features 114. For example, consider a pair of member entities A and B, a meta feature “long post activity” defining whether the respective entity has ever clicked a post having a length that is greater than a predetermined length threshold, and a non-meta feature “post length” defining the length, in characters, of a given post. In this scenario, the labels for member entity A might be [0, 126], while the labels for member entity B might be [1, 126].

As shown in FIG. 2B, the global block 118 can be trained during a global training phase 216. During global training phase 216, the global block 118 is initialized (as shown, initial global block 218) and meta trained via hybrid MAML 208 to generate the global block 118. The initial global block 218 can be meta trained via hybrid MAML 208 simultaneously with the initial meta block 206 (refer to FIG. 2A and Algorithms 1 and 2 below).

Turning now to the hybrid MAML algorithm 208 specifically, as used herein, “meta learning”, also referred to as “learning-to-learn”, refers to a technique in which a model θ is trained, across a variety of learning tasks, such that model θ is capable of adapting to any new task. One such meta learning technique is referred to as model-agnostic meta learning (referred to herein as baseline MAML). During baseline MAML, model parameters θ are learned such that the model has maximal generalization performance on a new task after the parameters have been updated through one or more gradient steps to a personalized θᵢ starting from θ. In some embodiments, a prediction function can be defined as fθ: x→y. The prediction function maps observations denoted by x to outputs denoted by y. In some embodiments, f can be any neural network-based function approximator with parameters θ. In some embodiments, each task can be defined as Tᵢ={(x₁,y₁), (x₂,y₂), . . . )} where xᵢ, yⱼ are independent and identically distributed samples from a specific task Tᵢ. A baseline MAML loss function L_{Ti}(f_{θi}) provides task-specific feedback based on the problem type using the task-specific model weights θᵢ. For a binary classification problem, loss can be cross entropy loss, for a regression problem, loss can be mean-squared error (MSE) loss, etc.

The goal of meta learning is for the meta learnt model to perform well on a distribution of learning tasks p(T). In some embodiments, the entire dataset is constructed as a set of tasks {T₁,T₂, . . . ,T_{N}}, where N is the number of tasks in total and each Tᵢ˜p(T) refers to a single task with all data points under task i. In some embodiments, each task level data Tᵢ is further split into two parts: a support set and a query set. In some embodiments, the support set is utilized for task-level personalization and the query set is utilized for maximizing generalization performance across tasks.

The baseline MAML algorithm mainly involves two stages: a task adaptation phase, referred to herein as the “inner loop”, and a meta-optimization phase, referred to herein as the “outer loop”. The goal of the inner loop is to learn task-level personalization by minimizing the loss on each task's support set data by performing gradient updates n times to obtain a set of personalized (fine-tuned) model weights θᵢ per task. At a task-level, the learning process presents an over-parameterized problem, with multiple solutions for θᵢ that can minimize the loss on the support set. However, the baseline MAML algorithm restricts the solution space by bootstrapping from θ as the starting point to learn θᵢ, creating a strong dependence of θᵢ on θ. The inner loop is also sometimes referred to as task-level fine-tuning as the inner loop fine tunes θ to learn personalized model parameters θᵢ for each task using a few samples from the task.

The goal of the outer loop is to update the model parameters θ such that the meta learnt model can maximize the generalization performance on a wide variety of tasks. The outer loop achieves this by doing a gradient update of θ using the losses computed on the query sets of each task from the per-task model parameters θᵢ. Note that this gradient update is done using all tasks since θ is shared across all tasks. The minimization of the losses of the different θᵢ parameters computed on the query sets represents the maximization of generalization performance across tasks. In some embodiments, the outer loop update involves a gradient through a gradient computation, which requires Hessian-vector products computation.

In essence, the baseline MAML algorithm learns the model parameters θ such that the model has maximal generalization performance on any new task after the parameters for that task are bootstrapped from θ and updated through one or more task-level gradient steps to a personalized θᵢ. Unfortunately, this approach inherently leads to storage and latency constraints that prevent arbitrary scaling. Consider, for example, the storage constraints of such a system in the context of a recommender platform for a connections network. If each user or each entity is treated as a task, the number of tasks can be extremely large, running in the order of millions or more. For example, there are over 1 billion members of the most popular connections network, and it is extremely expensive to store 1 billion θᵢ per user. Hence, storing the full set of parameters θᵢ as required for baseline MAML would be infeasible from a storage perspective. Next, consider latency constraints—recommendations are made online in near real time. Performing task-level fine-tuning during an inference call would cause significant inference latencies and would do so at high computation cost. Hence, real time fine-tuning is infeasible from a compute perspective.

Turning now to hybrid MAML 208, the storage and latency limitations inherent to baseline MAML are solved by building a new, hybrid variant of the MAML algorithm as follows:

Hybrid MAML 208-Training Algorithm (Algorithm 1)

```
Require: p(T): distribution over tasks
Require: α, β: step size/learning rate hyperparameters of inner and outer
loop, respectively, where the step size α is the task learning rate and β
is the learning rate used in the meta optimization step (also known as
global learning rate, and can be the same, or different, from the task
learning rate α)
Require: n: number of times to repeat the inner loop gradient updates
  1: randomly initialize θₘₑₜₐ, θ_{global}
  2: while not done do
  3:  Sample batch of tasks Tᵢ ~ p(T)
  4:  for all Tᵢ do
  5:  θ_{meta i} ← θmeta
  6:  repeat n times
  7:  Evaluate ∇ θ_{meta i} L_{Ti} (f_{θ}_{ₘₑₜₐ}ᵢ) with support set
  8:  θ_{meta i} ← θ_{meta i} − α∇ θ_{meta i} L_{Ti} (f_{θ}_{ₘₑₜₐ}ᵢ)
  9:  end
10: end for
11: Update θₘₑₜₐ and θ_{global} with query set:
$12 : {θ}_{meta} ← {θ}_{meta} - β {∇}_{{θ}_{meta}} {\sum }_{i = 1}^{N} {L}_{Ti} ( {f}_{{θ}_{meta} i} )$
$13 : {θ}_{global} ← {θ}_{global} - β {∇}_{{θ}_{global}} {\sum }_{i = 1}^{N} {L}_{Ti} ( {f}_{{θ}_{global} i} )$
14: end while
```

In this approach, the network is split into two block types—meta blocks 106 and a global block 118 (technically, for a specific task and a single implementation of the hybrid meta learning algorithm for that task there is only one meta block, the meta block associated with the entity/task, but the overall network will have any number of such meta blocks). The meta block 106 has parameters denoted by θₘₑₜₐ and defines the sub-network for meta learning. Hence, for every task Tᵢ, the process begins with θₘₑₜₐ, and fine-tuning is leveraged to produce personalized sub-networks θₘₑₜₐ₁, θₘₑₜₐ₂, . . . , θ_{metaN} for N tasks. Global block 118 has parameters denoted by θ_{global} and defines the sub-network that is shared across all tasks.

Algorithm 1 (refer above) provides the steps for hybrid meta training and can be thought of in terms of two loops: In the inner loop (lines 4-10), only the meta block parameters θ_{meta i} for each task Tᵢ are updated using the support set data from each task. In the outer loop (lines 11-13), both meta block parameters θₘₑₜₐ and global block parameters θ_{global} are updated with the query set of training data. For the meta block parameter update, the loss for the gradient is computed using each task's fine-tuned model parameters θ_{meta i}. For the global block parameter update, the loss for the gradient is computed using the model parameters θglobal. Thus, by the end of hybrid meta training, a set of model parameters (θₘₑₜₐ, θ_{global}) are learned for both blocks. Observe that θₘₑₜₐ is obtained by training against a variety of tasks and is therefore capable of adapting quickly to any new or old task given just a few data points.

While hybrid meta learning alone (refer to Algorithm 1) can offer a number of benefits over conventional meta learning, more can be done via a specific implementation of meta embedding generation. Specifically, it is desirable to serve the meta block 106 offline, while serving the global block 118 online during inference. In order to enable this type of configuration, a meta embedding generation algorithm (refer below to Algorithm 2) is introduced that can be run at a decoupled cadence from Algorithm 1. For example, in some embodiments, Algorithm 2 can run at a regular cadence (e.g., once per day, once per week, etc.) to do fine-tuning of the meta block 106 to output meta embeddings 108. Algorithm 2 provides a set of steps for updating θₘₑₜₐ frequently via meta fine-tuning and producing embeddings for online serving of the global block 118. In lines 3-6, recent samples of each task are used to update θₘₑₜₐ and obtain θ_{meta i} for that task by taking k gradient descent steps. Note that the number of gradient steps k can be different from the number of inner loop gradient steps n taken during Algorithm 1 training. In some embodiments, meta block parameters are bootstrapped with θₘₑₜₐ every time the meta embedding generation flow of Algorithm 2 is run (see line 2). Observe that, after getting θ_{meta i} for each task, Algorithm 2 immediately scores the meta block with θ_{meta i} as the model parameters using the most recent sample xᵢ for that task as shown in line 7. The output of the meta block is then scored as meta embedding Eᵢ for that task.

Hybrid MAML 208-Meta Embedding Generation Algorithm (Algorithm 2)

Require: k: number of times to repeat the fine-tuning gradient updates

1: for each Tᵢ ∈ T do
2: θ_{meta i} ← θₘₑₜₐ
3: repeat k times
4: Evaluate ∇ _{θ}_{_{meta i}} L_{Ti} (f_{θ}_{_{meta i}}) with recent samples of Tᵢ
5: θ_{meta i} ← θ_{meta i} − α∇ _{θ}_{_{meta i}} L_{Ti} (f_{θ}_{_{meta i}})
6: end
7: Score the most recent sample xᵢ using θ_{meta i} to obtain the output of the meta

block (meta embedding) Eᵢ

8: end for

Note that, for a given meta block 106, the input only contains entity-specific meta features 110 and will not contain any other item specific features for a task (e.g., non-meta features 114). Hence, scoring a personalized meta block 106 with the most recent sample xᵢ corresponds to scoring with the latest entity-specific meta features 110 and obtaining an embedding (e.g., meta embedding 108) for that entity.

Advantageously, in some embodiments, instead of persisting all the updated task-level model parameters, only the output of each meta block 106 is stored. Notably, this output (the meta embedding 108) is a fix-sized vector. In some embodiments, aggregator 112 serves as a feature store and the meta embeddings 108 will be persisted and stored in aggregator 112 for retrieval during online inference (refer to online pipeline 104). Advantageously, this configuration reduces the required storage from a set of model weights per task (on the order of quadrillions of parameters for fully scaled connections networks) to an embedding vector per task (on the order of tens of billions of parameters). Global block 118 can be served online as per the deployment and inference process previously discussed. In this manner, when the hybrid meta learning recommendation service 100 receives a new scoring request 122 (that is, a call for predictions 120), the online pipeline 104 can retrieve all features as well as the latest version of meta embeddings 108 from aggregator 112 (acting, in this capacity, as a feature store), and can score those retrieved features with the global block θ_{global}.

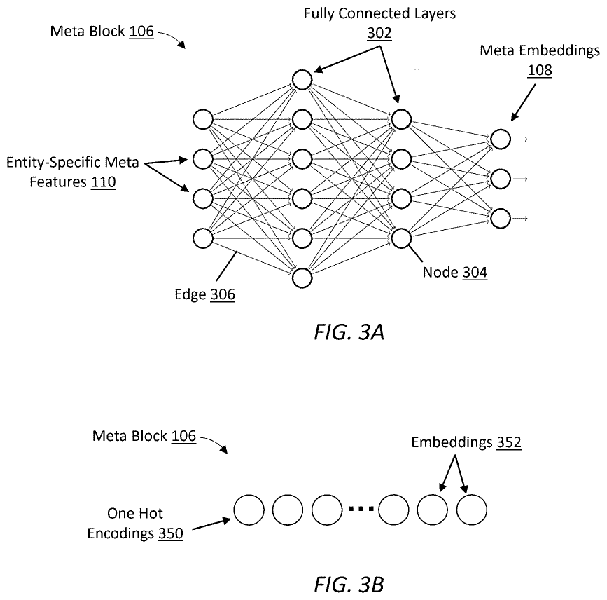

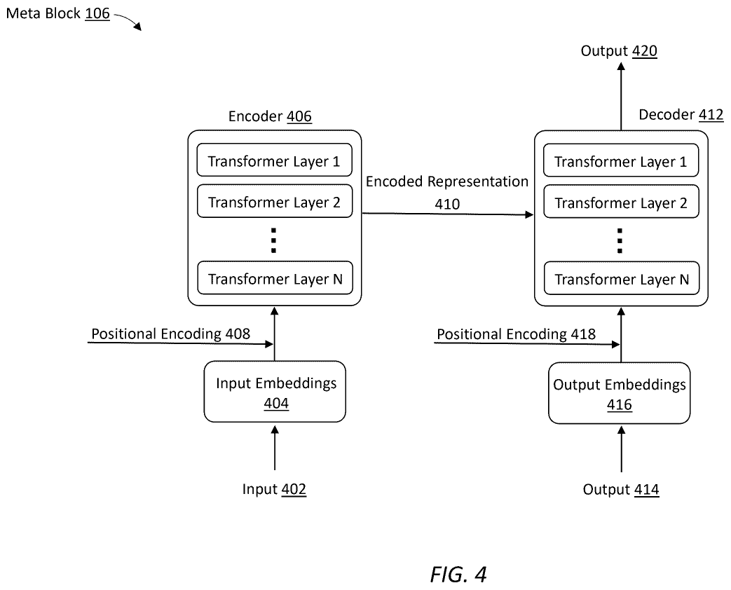

One notable advantage of the hybrid meta learning architecture and training regimes discussed previously is an almost complete flexibility in the actual underlying architecture of the meta blocks 106 (thus, the “model agnostic” moniker). In short, given that meta block 106 is served in the offline pipeline 102 using a sequence of samples per task (refer to Algorithm 1 and Algorithm 2), the meta blocks 106 can be implemented using a range of simple to complex architectures for personalization, such as, for example, via a dense multi-layer perception (MLP), ID embedding layer, or transformer. FIG. 3A shows an example MLP-type implementation for meta block 106. FIG. 3B shows an example ID embedding layer-type implementation for meta block 106. FIG. 4 shows an example transformer-type implementation for meta block 106. Other architectures are possible (e.g., sequential models with and without attention, LSTMs, dilated causal convolutional nets, masked attention models, etc.), and all such configurations are within the contemplated scope of this disclosure.

Turning now to FIG. 3A, in some embodiments, meta block 106 is implemented as a multilayer perceptron, which is a type of feedforward artificial neural network that consists of multiple layers of interconnected nodes. In this implementation, the meta block 106 includes one or more fully connected layers 302 using entity-specific meta features 110 as input (collectively defining an input layer) and meta embeddings 108 (the task representation) as the output of the last fully connected layer (the output layer). The depth, width, dimensionality, etc., of the MLP need not be particularly limited, and the construction shown in FIG. 3A is merely illustrative.

In some embodiments, meta block 106 includes one or more nodes 304 (neurons) arranged in each of the fully connected layers 302. Nodes 304 in adjacent fully connected layers 302 are connected by weighted edges 306, where the weight of a respective edge represents the strength of the connection between the respective nodes 304. These weights are adjusted during the learning process. In some embodiments, each node 304 in the meta block 106 performs a weighted sum of its inputs, adds a bias term, and then, optionally, applies a non-linear activation function to produce an output. The nonlinear activation function, such as a rectified linear unit (ReLU), sigmoid, or tanh function, are applied to the outputs of each node 304 to introduce nonlinearity, allowing the meta block 106 to learn more complex patterns.

Turning now to FIG. 3B, in some embodiments, meta block 106 is implemented as an ID embedding layer. In this implementation, the meta block 106 includes one or more one hot encodings 350, such as, for example, encoded memberID (or any other entity ID), and the output of the meta block 106 includes one or more corresponding trained member (or other entity) embeddings 352. In some embodiments, the one hot encodings 350 are the entity-specific meta features 110 and the embeddings 352 are the meta embeddings 108. In some embodiments of this implementation, hybrid meta learning recommendation service 100 (refer to FIG. 1) only chooses to meta learn entity (member, task, etc.) embeddings for entities having more than a threshold number of task-level samples available for fine-tuning and the other entities (those having fewer than the threshold number of task-level samples available) are mapped to a default identifier.

Turning now to FIG. 4, in some embodiments, meta block 106 is implemented as a transformer-type architecture, such as those relied upon in some large language models (LLMs). In some embodiments, meta block 106 (implemented as a transformer or as an LLM having one or more transformer layers) includes an encoder 406 trained to generate embeddings (e.g., the meta embeddings 108). While not meant to be particularly limited, the meta block 106 and/or encoder 406 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 4, the transformer-based architecture begins with an input 402. The input 402 denotes an input provided by a user (or upstream system) and can be represented as a sequence of tokens, individual words or sub-words, from which input embeddings 404 can be generated. The input embeddings 404 represent the tokens within the input 402 as numbers, which can be processed using encoder 406. In some embodiments, a positional encoding 408 can be generated to encode the position of each token in input 402 as a set of numbers. These numbers can be fed into the encoder 406 with the input embeddings 404, allowing the transformer-based architecture to more effectively understand the order of words in a sentence and to thereby generate grammatically correct and semantically meaningful outputs.

The encoder 406 processes the input embeddings 404 and the positional encoding 408 and generates, for the input 402, an encoded representation 410 (in this implementation, the meta embeddings 108) that captures the meaning and context of the input 402. To accomplish this, encoder 406 applies a series of self-attention transformer layers (or simply, “transformer layers”), which are a series of hidden states that represent the input 402 at different levels of abstraction. The encoder 406 can include any number of these transformer layers, as desired. In some embodiments, the encoded representation 410 is provided to a decoder 412.

The decoder 412 similarly includes a number of transformer layers, as desired, except that the decoder 412 processes an output 414. In most implementations, the output 414 is a right-shifted copy of the input 402, meaning that the decoder 412 can only use the previous words for next-word prediction. In some embodiments, output embeddings 416 can be generated from the output 414 to represent the tokens in the output 414 as numbers, in a similar manner as described with respect to the encoder 406. A positional encoding 418 can be added to the output embeddings 416 to encode the position of each token in output 414 as a set of numbers. The decoder 412 can be trained by minimizing a loss function (also known as an objective function, which quantifies a difference between a predicted output and a known true value) using, for example, gradient descent. Once trained, the transformer-based meta block 106 can be used during an inference phase to generate an output 420, which can be thought of as a next-word probability (that is, how likely is the next word in the sequence to be x, or y, etc.). In some configurations, the transformer-based architecture includes a linear layer and SoftMax layer (omitted for clarity) to transform a raw output from the decoder 412 into the output 414. For example, after the decoder 412 produces a raw output (e.g., output embeddings), the linear layer can map the output embeddings to a higher-dimensional space, thereby transforming the output embeddings into a same original input space as the input 402. The SoftMax function can be used to generate a probability distribution for each output token in the vocabulary, enabling the transformer-based meta block 106 to generate output tokens with probabilities (e.g., the output 420).

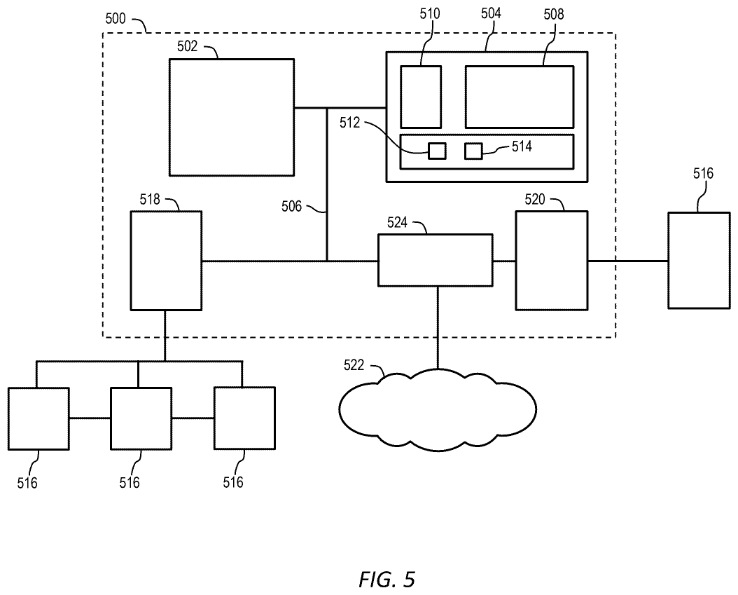

FIG. 5 illustrates aspects of an embodiment of a computer system 500 that can perform various aspects of embodiments described herein. In some embodiments, the computer system(s) 500 can implement and/or otherwise be incorporated within or in combination with the hybrid meta learning recommendation service 100 (refer to FIG. 1). In some embodiments, a computer system 500 can be implemented server-side. For example, a remote computer system 500 can be configured to receive a request 122 and to generate, in response, predictions 120.

The computer system 500 includes at least one processing device 502, which generally includes one or more processors or processing units for performing a variety of functions, such as, for example, completing any portion of the hybrid meta learning recommendation service 100 described previously. Components of the computer system 500 also include a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media. For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to any of the block diagrams described herein. The computer system 500 is not so limited, as other modules may be included depending on the desired functionality of the computer system 500. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 502 can also be configured to communicate with one or more external devices 516 such as, for example, a keyboard, a pointing device, and/or any devices (e.g., a network card, a modem, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

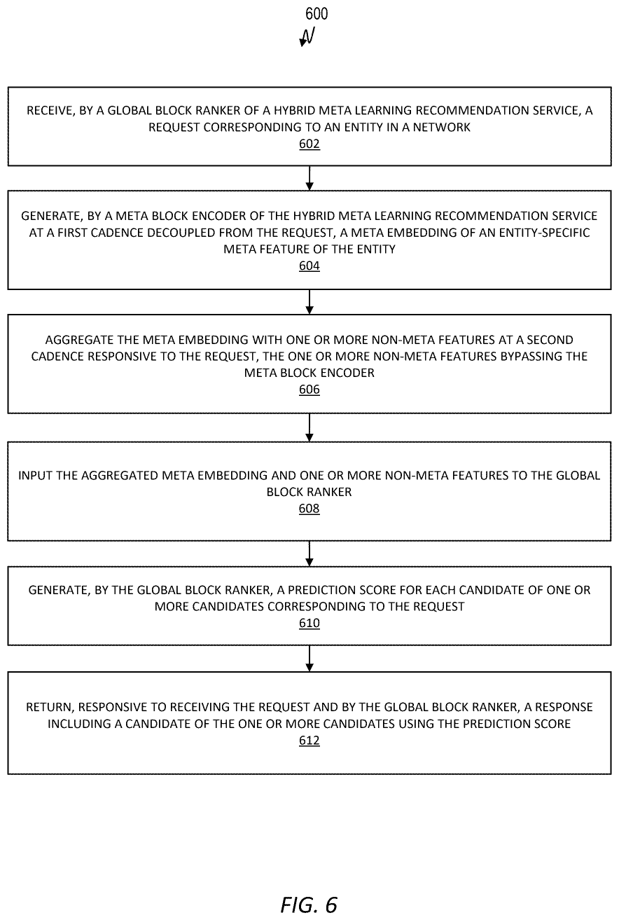

Referring now to FIG. 6, a flowchart 600 for hybrid meta learning is generally shown according to an embodiment. The flowchart 600 is described with reference to FIGS. 1 to 5 and may include additional steps not depicted in FIG. 6. Although depicted in a particular order, the blocks depicted in FIG. 6 can be, in some embodiments, rearranged, subdivided, and/or combined.

At block 602, the method includes receiving, by a global block ranker of a hybrid meta learning recommendation service, a request corresponding to an entity in a network.

At block 604, the method includes generating, by a meta block encoder of the hybrid meta learning recommendation service at a first cadence decoupled from the request, a meta embedding of an entity-specific meta feature of the entity. In some embodiments, the meta embedding is generated in an offline pipeline running at the first cadence.

At block 606, the method includes aggregating the meta embedding with one or more non-meta features at a second cadence responsive to the request, the one or more non-meta features bypassing the meta block encoder. In some embodiments, the meta embedding is aggregated with the one or more non-meta features in an online pipeline running at the second cadence.

At block 608, the method includes inputting the aggregated meta embedding and one or more non-meta features to the global block ranker. In some embodiments, the aggregated meta embedding and one or more non-meta features are input to the global block ranker in the online pipeline.

At block 610, the method includes generating, by the global block ranker, a prediction score for each candidate of one or more candidates corresponding to the request.

At block 612, the method includes returning, responsive to receiving the request and by the global block ranker, a response comprising a candidate of the one or more candidates using the prediction scores.

In some embodiments, the first cadence is a daily cadence, and the second cadence is a real-time or near real-time cadence. As used herein, executing a task or set of tasks at a “daily cadence” means executing the task(s) at least once every 24 hours (that is, on a daily basis). A daily cadence might execute everyday at the same time, or at least once in every 24-hour window, as desired. As used herein, executing a task or set of tasks at a “real-time cadence” means executing the task(s) continuously or immediately (on the order of less than one minute) in response to an initiating event (e.g., an initial event or action which triggers the execution of the task), such as the receiving of a request corresponding to an entity in a network. For example, processing a request corresponding to an entity in a network (e.g., a request for a feed post for a particular user, an advert selection, a connection recommendation for a member, an advert-CTR prediction task, a user-item CTR prediction task, etc.) at a real-time cadence means receiving, executing, and responding to the request within a minute of receiving the request. As used herein, executing a task or set of tasks at a “near real-time cadence” means executing the task(s) on the order of a few minutes in response to an initiating event, such as the receiving of a request corresponding to an entity in a network.

In some embodiments, the method further includes training the meta block encoder to generate meta embeddings from entity-specific meta features using a hybrid MAML training architecture in which the network is split into a meta block and a global block. In some embodiments, only the meta block is meta learned. In some embodiments, the meta block is meta learned in the offline pipeline running at the first cadence and the meta embedding is aggregated with the one or more non-meta features in the online pipeline running at the second cadence.

In some embodiments, training the meta block encoder includes a first training phase and a second training phase. In some embodiments, the first training phase includes training an initial meta block to generate a pre-trained meta block. In some embodiments, the second training phase includes fine-tuning the pre-trained meta block on entity-specific data to generate an entity-specific meta block.

In some embodiments, the meta block encoder is a multi-layer perceptron having a plurality of nodes, edges, and fully connected layers. In some embodiments, the fully connected layers include an input layer and an output layer. In some embodiments, the input layer includes the entity-specific meta features and the output layer includes the meta embeddings.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving, by a global block ranker of a hybrid meta learning recommendation service, a request corresponding to an entity in a network;
generating, by a meta block encoder of the hybrid meta learning recommendation service at a first cadence decoupled from the request, a meta embedding of an entity-specific meta feature of the entity;
aggregating the meta embedding with one or more non-meta features at a second cadence responsive to the request, the one or more non-meta features bypassing the meta block encoder;
inputting the aggregated meta embedding and one or more non-meta features to the global block ranker;
generating, by the global block ranker, a prediction score for each candidate of one or more candidates corresponding to the request; and
returning, responsive to receiving the request and by the global block ranker, a response comprising a candidate of the one or more candidates using the prediction score.

2. The method of claim 1, wherein the first cadence is a daily cadence, and the second cadence is a real-time or near real-time cadence.

3. The method of claim 1, further comprising training the meta block encoder to generate meta embeddings from entity-specific meta features using a hybrid model-agnostic meta-learning (MAML) training architecture in which the network is split into a meta block and a global block.

4. The method of claim 3, wherein the meta block is meta learned in an offline pipeline running at the first cadence, and wherein the meta embedding is aggregated with the one or more non-meta features in an online pipeline running at the second cadence.

5. The method of claim 3, wherein training the meta block encoder comprises a first training phase and a second training phase.

6. The method of claim 5, wherein the first training phase comprises training an initial meta block to generate a pre-trained meta block, and wherein the second training phase comprises fine-tuning the pre-trained meta block on entity-specific data to generate an entity-specific meta block.

7. The method of claim 1, wherein the meta block encoder comprises a multi-layer perceptron having a plurality of nodes, edges, and fully connected layers, the fully connected layers comprising an input layer and an output layer, and wherein the input layer comprises entity-specific meta features and the output layer comprises meta embeddings.

8. A system comprising a memory, computer readable instructions, and one or more processors for executing the computer readable instructions, the computer readable instructions controlling the one or more processors to perform operations comprising:
receiving, by a global block ranker of a hybrid meta learning recommendation service, a request corresponding to an entity in a network;
generating, by a meta block encoder of the hybrid meta learning recommendation service at a first cadence decoupled from the request, a meta embedding of an entity-specific meta feature of the entity;
aggregating the meta embedding with one or more non-meta features at a second cadence responsive to the request, the one or more non-meta features bypassing the meta block encoder;
inputting the aggregated meta embedding and one or more non-meta features to the global block ranker;
generating, by the global block ranker, a prediction score for each candidate of one or more candidates corresponding to the request; and
returning, responsive to receiving the request and by the global block ranker, a response comprising a candidate of the one or more candidates using the prediction score.

9. The system of claim 8, wherein the first cadence is a daily cadence, and the second cadence is a real-time or near real-time cadence.

10. The system of claim 8, the operations further comprising training the meta block encoder to generate meta embeddings from entity-specific meta features using a hybrid model-agnostic meta-learning (MAML) training architecture in which the network is split into a meta block and a global block.

11. The system of claim 10, wherein the meta block is meta learned in an offline pipeline running at the first cadence, and wherein the meta embedding is aggregated with the one or more non-meta features in an online pipeline running at the second cadence.

12. The system of claim 10, wherein training the meta block encoder comprises a first training phase and a second training phase.

13. The system of claim 12, wherein the first training phase comprises training an initial meta block to generate a pre-trained meta block, and wherein the second training phase comprises fine-tuning the pre-trained meta block on entity-specific data to generate an entity-specific meta block.

14. The system of claim 8, wherein the meta block encoder comprises a multi-layer perceptron having a plurality of nodes, edges, and fully connected layers, the fully connected layers comprising an input layer and an output layer, and wherein the input layer comprises entity-specific meta features and the output layer comprises meta embeddings.

15. A computer program product comprising a computer readable storage medium having program instructions embodied therewith, the program instructions executable by one or more processors to cause the one or more processors to perform operations comprising:
receiving, by a global block ranker of a hybrid meta learning recommendation service, a request corresponding to an entity in a network;
generating, by a meta block encoder of the hybrid meta learning recommendation service at a first cadence decoupled from the request, a meta embedding of an entity-specific meta feature of the entity;
aggregating the meta embedding with one or more non-meta features at a second cadence responsive to the request, the one or more non-meta features bypassing the meta block encoder;
inputting the aggregated meta embedding and one or more non-meta features to the global block ranker;
generating, by the global block ranker, a prediction score for each candidate of one or more candidates corresponding to the request; and
returning, responsive to receiving the request and by the global block ranker, a response comprising a candidate of the one or more candidates using the prediction scores.

16. The computer program product of claim 15, wherein the first cadence is a daily cadence, and the second cadence is a real-time or near real-time cadence.

17. The computer program product of claim 15, the operations further comprising training the meta block encoder to generate meta embeddings from entity-specific meta features using a hybrid model-agnostic meta-learning (MAML) training architecture in which the network is split into a meta block and a global block.

18. The computer program product of claim 17, wherein the meta block is meta learned in an offline pipeline running at the first cadence, and wherein the meta embedding is aggregated with the one or more non-meta features in an online pipeline running at the second cadence.

19. The computer program product of claim 17, wherein training the meta block encoder comprises a first training phase and a second training phase.

20. The computer program product of claim 19, wherein the first training phase comprises training an initial meta block to generate a pre-trained meta block, and wherein the second training phase comprises fine-tuning the pre-trained meta block on entity-specific data to generate an entity-specific meta block.
